(19) United States
(12) Patent Application Publication
(10) Pub. No.: US 2008/0236273 A1
(43) Pub. Date: Oct. 2, 2008

(54) Mass airflow sensing system including resistive temperature sensors and a heating element

(75) Inventors: Anthony M. Dmytriw, DeKalb, IL (US); Craig S. Becke, London, OH (US)

Correspondence Address: Bryan Anderson;Honeywell International Inc., 101 Columbia Rd., P.O. Box 2245, Morristown, NJ, 07962, US

(73) Assignee: Honeywell International Inc.

(21) Appl. No.: 11/729,130

(22) Filed: Mar. 27, 2007

(51) Int. Cl. G01F 1/69

(52) U.S. Cl. 73/204.17; 73/204.25

(57) ABSTRACT

A mass airflow sensor is disclosed that includes a heating element comprising an upstream side and a downstream side. Two resistive temperature sensors are placed on each side of the heating element and assuming mass air/liquid flows in a direction from left to right. The resistors are configured electrically in a Wheatstone bridge configuration. A regulated voltage is applied across the mass flow sensing, Wheatstone bridge. The regulated voltage is set high enough to produce self-heating effects on the sensing bridge. The central heating element will also be heated. As mass air/liquid flows across the temperature sensors and the heating element, the upstream (RU1 and RU2) resistors are cooled and the downstream (RD1 and RD2) resistors are heated. The resistance in the resistive temperature sensors changes with temperature creating a differential voltage signal proportional to the regulated voltage applied to the sensing Wheatstone bridge and rate of mass air/liquid flow.

### TECHNICAL FIELD

Embodiments are generally related to sensing devices and components. Embodiments are also related to mass fluid flow sensors. Embodiments are additionally related to resistive temperature sensors used to detect mass airflow.

### BACKGROUND OF THE INVENTION

Sensors are used in a variety of sensing applications, such as, for example, detecting and/or quantifying the composition of matter, detecting and/or quantifying the presence of a particular substance from among many substances, and detecting and/or quantifying a mass flow rate of fluid (e.g., in air liquid form). The industrial, commercial, medical, and the automotive industries in particular require many ways to quantify the amount of gaseous and liquid mass flow rates. For example, in the medical industry, an airflow sensor is often employed to monitor and/or control a patient's breathing. Two examples of this include sleep apnea devices and oxygen conserving devices. Similarly, airflow sensors are often employed in microcomputer cooling units to detect the presence and amount of local airflow in, through, and around the cooling units.

Historically, mass flow sensors have been constructed with one temperature-sensing resistor “upstream” and one temperature sensing resistor “downstream,” where “upstream” and “downstream” generally indicate the direction of mass flow. One advancement in mass flow sensors in microchip environments, the “Wheatstone bridge” circuit, is often configured with external, off the chip, resistors. This historical configuration can be improved as described by the inventors by implementing a full Wheatstone bridge, all four resistor branches, each having a temperature sensing resistor, and can be formed on a sensing chip, to allow for an increase in sensitivity, increase the sensitivity to offset ratio of the signal and can be measured from the circuit, and decrease the bias voltage needed to be applied to the mass airflow sensor.

A Wheatstone bridge can be used to detect mass flow. For example, in a “full” Wheatstone bridge configuration, all four legs comprise variable resistors. In one configuration, resistive temperature detectors-resistors that vary in resistance with temperature are used in each leg. A heating element situated between the two sides creates a roughly even thermal distribution about the heating element. As air, for example, passes from one side to the other side of the bridge, heat is conducted away from the “upstream” side of a unit to the “downstream” side of the unit, cooling the upstream side and heating the downstream side.

As the resistance of the two sides varies with temperature, the resultant temperature differential between the two sides causes a measurable voltage difference between the two sides. This voltage difference can be correlated to the difference in temperature. As the temperature change is a function of the air mass flow rate, the voltage difference can also be correlated to the mass flow rate.

Previous full Wheatstone bridge configurations, however, also often incur a low signal to noise ratio, particularly for very high or very low flow rates. A low signal to noise ratio reduces the accuracy and resolution of the bridge measurements and can cause difficulties in quantifying the mass flow rates under investigation.

Referring to FIG. 1, labeled as a “prior art” illustrates a circuit 100 currently used by the mass flow sensors to sense mass air/liquid flow. The figure shows a heated heating element RH 104, which is the only part of the sensor that is heated via electrical power source 103. Temperature sensing resistors RU1 105, RU2 106, RD1 108 and RD2 107 are not heated but are powered from a power source 102. As air 101, for example, passes from one side to the other side of the bridge in a central heating unit, heat is conducted away from the “upstream” side of a unit to the “downstream” side of the unit, cooling the upstream side and heating the downstream side. The low-level differential output signal resulting from this cooling and heating process is indicated as a voltage difference between positive signal 109 and negative signal 110.

Referring to FIG. 2, labeled as “prior art” illustrates a circuit 200 as currently used in mass flow sensing to sense mass air/liquid flow. The figure illustrates that a central heating element is not always used where temperature sensing resistors RU1 205, RU2 206, RD1 208, and RD2 207 are self heated and used to sense mass air/liquid flow 201 as fluid passes from RU1 to RD1 over the temperature sensing resistors 205-208. Temperature sensing resistors RU1 205, RU2 206, RD1 208, and RD2 207 are powered from power supply 202. The low-level differential output signal is the difference taken from outputs as indicated at positive and negative outputs 209 and 210.

Therefore, what is required is a system, apparatus, and/or method that provides an improved sensitivity to high and/or low flow rates that overcomes at least some of the limitations of previous systems and/or methods. The present invention will increase the sensitivity of the mass airflow sensor, increase the sensitivity to offset ratio of the signal, and decrease the bias voltage needed to be applied to the sensor.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved mass airflow sensing device.

It is another aspect of the present invention to provide for a sensor with an increased sensitivity.

It is another aspect of the present invention to provide for a sensor with increase in the sensitivity to offset ratio of the signal.

It is further aspect of the present invention to provide for a sensor to decrease the bias voltage needed to be applied to the sensor.

The aforementioned aspects and other objectives and advantages can now be achieved as described herein. A mass airflow sensing apparatus is disclosed that includes a heating element comprising an upstream side and a downstream side. Two resistive temperature sensors are placed on each side of the heating element and assuming mass air/liquid flows in a direction from the upstream side to the downstream side of the unit. The resistors are configured electrically in a Wheatstone bridge configuration. A regulated voltage is applied across the mass flow sensing, Wheatstone bridge. The regulated voltage is set high enough to produce self-heating effects on the sensing bridge. The central heating element located within the Wheatstone bridge configuration between upstream and downstream resistors, will also be heated. As mass air/liquid flows across the temperature sensors and the heating element, the upstream (RU1 and RU2) resistors are cooled by incoming fluid flow and the downstream (RD1 and RD2) resistors are heated by the flow over the heating element. The resistance in the resistive temperature sensors changes with temperature creating a differential voltage signal proportional to the regulated voltage applied to the sensing Wheatstone bridge and rate of mass air/liquid flow.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1, labeled as “prior art”, illustrates a sensing system within which mass flow sensors sense mass air/liquid flow using a heating element within a Wheatstone bridge configuration of temperature reactive resistors; and

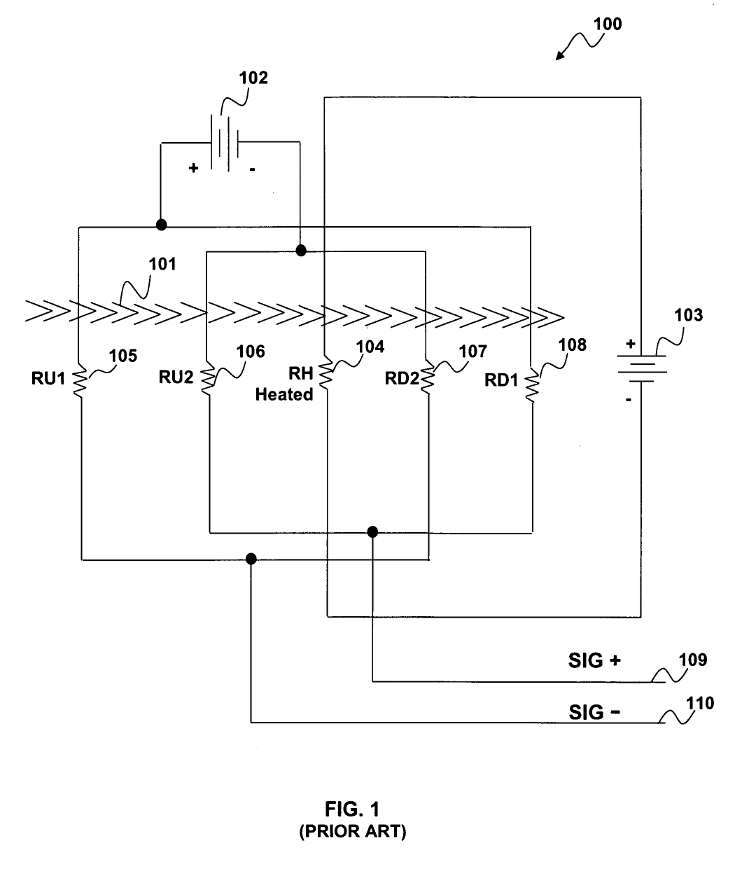

FIG. 2, labeled as “prior art”, illustrates another sensing system adapted to sense mass air/liquid flow using mass flow sensors in the form of heated temperature sensing resistors formed in a Wheatstone bridge configuration.

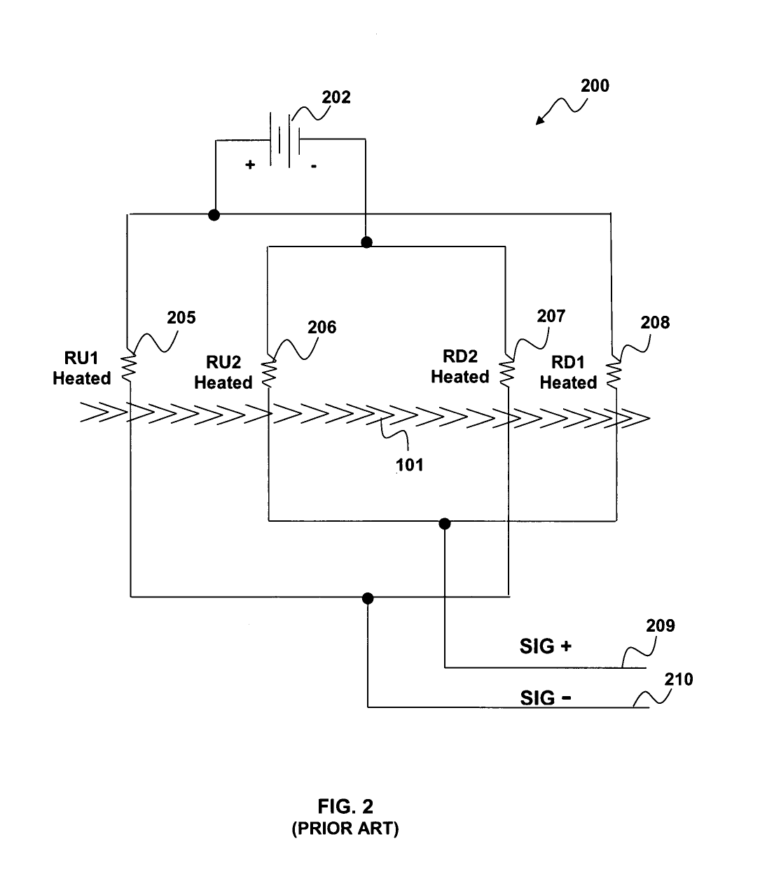

FIG. 3 illustrates a sensing system in accordance with features of the present invention in which heated thermal sensing resistors and formed in a Wheatstone bridge configuration and a heated heating element is located as a central element within the Wheatstone bridge between upstream and downstream resistors, the system used to more accurately sense mass flow.

FIG. 4 illustrates system modules in accordance with features of the present invention, said module operating together for providing a compensated, ratiometric signal from a regulated, mass flow sensing system.

FIG. 5 illustrates a high level flow chart of operations depicting logical operational steps for sensing mass airflow, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope thereof.

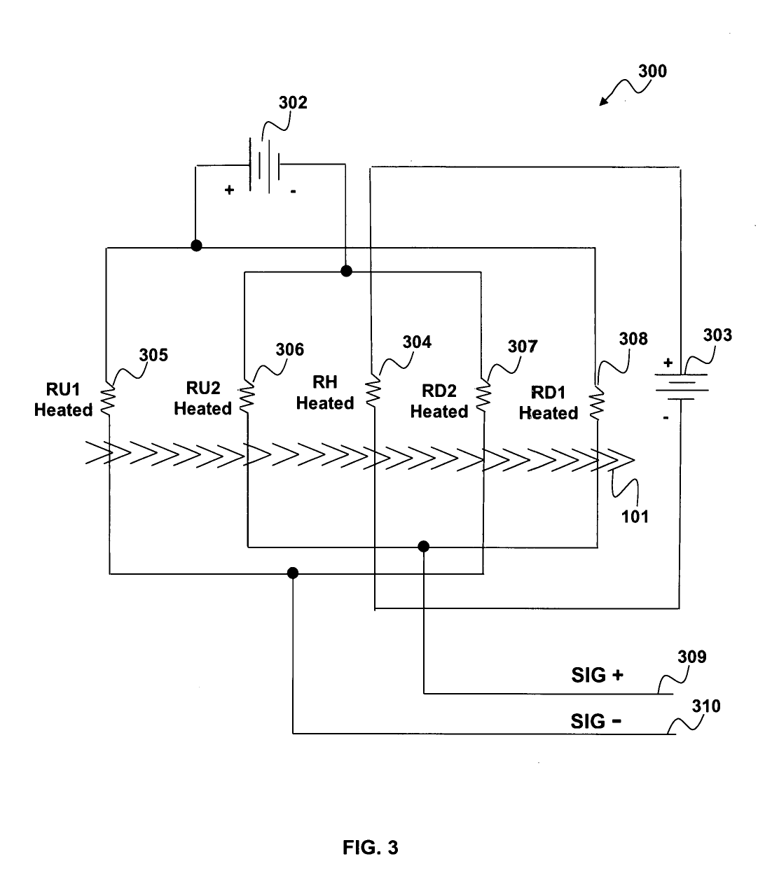

FIG. 3 illustrates a system 300 by which heating the sense resistors and heating a central element to sense mass flow, which can be implemented in accordance with a preferred embodiment. This system as illustrated is beneficial and shows how to eliminate the problems that were associated with this approach. The temperature sense resistors RU1 304, RU2 305, RD1 308, and RD2 307 are self heated by applying power to them. The sensing power supply 302 and heater power supply 303 are external excitation sources. Self heating increases the temperature of resistors in the sensing system when power is applied to them by power supply 302. The central heating element RH 304 is also heated when power by power supply 303. As mass air/liquid flows in a direction from left to right as indicated by flow 301 across the temperature sense resistors RU1 305, RU2 306, RD1 308, and RD2 307 and the heating element 304, the upstream resistors RU1 305 and RU2 306 are cooled and the downstream RD1 308 and RD2 307 resistors are heated. The resistance in the temperature sense resistors changes with temperature creating a differential voltage signal 309 proportional to the regulated voltage applied to the sensing Wheatstone bridge and rate of mass air/liquid flow.

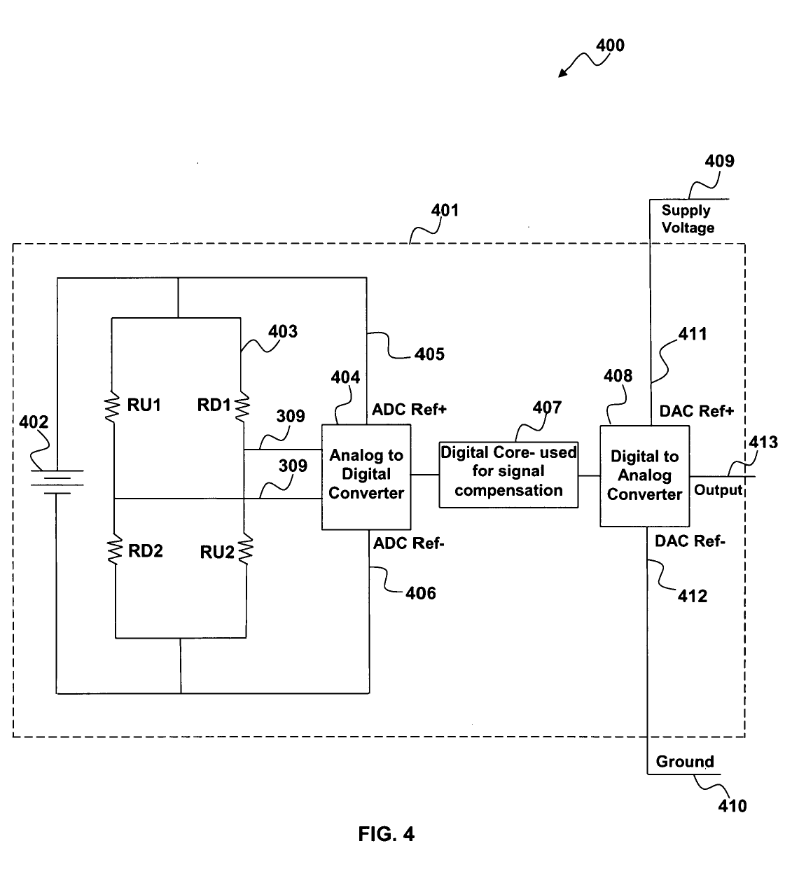

FIG. 4 illustrates a system 400 for providing a compensated, ratiometric signal from a regulated, self heating power supply, which can be implemented in accordance with a preferred embodiment. The figure illustrates a compensated sensor module 401. RTDs (resistance-temperature detectors) require a current or voltage excitation to produce an electrical output. A regulated voltage supply 402 is applied to the resistive temperature sensing Wheatstone bridge 403 to maintain high-resolution and accuracy within the measurement system. Care should be exercised in selecting the excitation source for the sensor and in the field-wiring scheme used in conveying the low-level analog signals 309/310 from the resistive temperature sensing Wheatstone bridge 403 to the A/D converter 404. The same reference source is used for both the RTD excitation and the A/D converter 404. A given percentage change in excitation is countered by the same percentage change in the conversion process (or vice versa). An ADC output code from the A/D converter 404 is a digital representation of the ratio of the converter's input to its reference ADC Ref+ 405 and ADC Ref− 406. Since the input to the converter and its reference are derived from the same excitation source, changes in the excitation do not introduce measurement errors. The digital core 407 performs signal compensation on the output signal from A/D converter 404. The D/A converter 408 converts the signal to an analog ratiometric output 413. The ratiometric output 413 is the ratio of D/A converters 408 input to its reference DAC Ref+ 411 and DAC Ref− 412. The D/A converter 408 is coupled to a supply voltage 409 and a common ground 410 which makes the external excitation source. Note that in FIGS. 3-4, identical or similar parts and/or elements are generally indicated by identical reference numerals. Thus reference numeral 309 as depicted in FIG. 3 and reference numeral 309 depicted in FIG. 4 refer to the same component in FIG. 4.

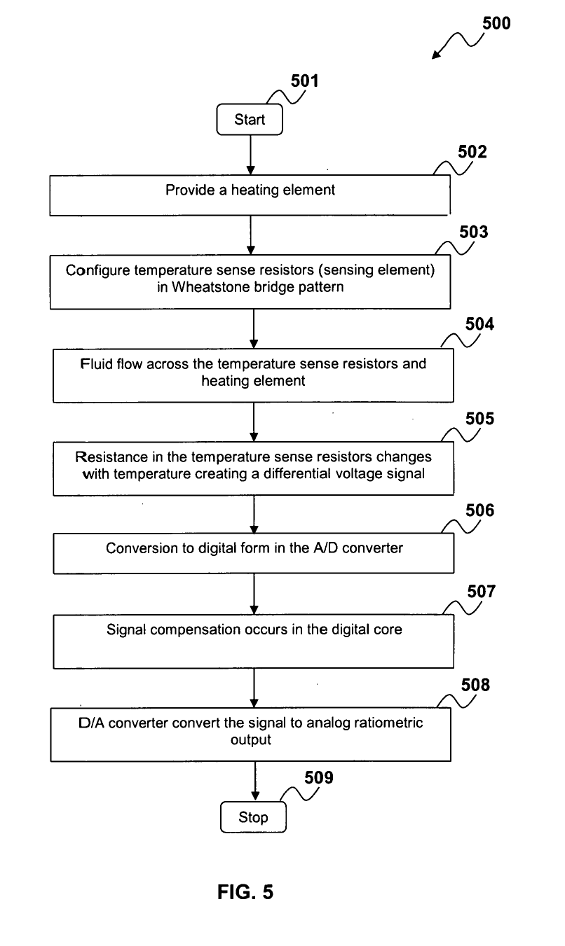

Referring to FIG. 5, a high level flow chart 500 of a method is illustrated, which describes logical operational steps for sensing mass air flow, and which can be implemented in accordance with a preferred embodiment. Note that the process or method 500 described in FIG. 5 can be implemented in context of a module such as compensated sensor module 401 of system 400 and as depicted in FIG. 4 using a Wheatstone bridge configuration of heated thermisters as illustrated in FIG. 3. The mass airflow sensing can be initiated, as indicated at block 501. A central heating element is provided as depicted in block 502. As described next at block 503, four temperature sense resistors (sensing element) are configured in a Wheatstone bridge pattern. The mass fluid flows in a direction from left to right across the temperature sense resistors and heating element(s), as depicted at block 504. The resistance in the temperature sense resistors changes with temperature changes creating a differential voltage signal proportional to the regulated voltage applied to the sensing Wheatstone bridge and rate of mass air/liquid flow, as depicted at block 505.

As described at block 506, the low-level analog signal from the resistive temperature sensing Wheatstone bridge is converted to digital form at A/D converter. Temperature compensation of the signal occurs at digital core, as indicated at block 507. The D/A converter convert the signal to analog ratiometric output which is the ratio of D/A converters input to its reference voltages, as illustrated at block 508. The process can then terminate, as indicated at block 509.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for sensing mass fluid flow comprising:
four self-heating temperature sensing elements arranged in a Wheatstone bridge circuit, wherein two self-heating temperature sensing elements represent an upstream location and two self-heating temperature sensing elements represent a downstream location;
a central heating element located in between the upstream and downstream locations, whereln an analog signal is produced from the Wheatstone bridge circuit;
an analog-to-digital converter for converting the analog signal from the Wheatstone bridge into a digital signal;
a digital core for providing signal compensation to digital signal provided from the analog-to digital converter; and
a digital-to-analog converter for converting the digital signal into an analog signal following signal compensation by said digital core.

2. (canceled)

3. The system of claim 1 further comprising at least one regulated supply voltage for providing power to the central heating element and the sensing resistors.

4. The system of claim 1 wherein said central heating element comprises a heating resistor.

5. The system of claim 1 wherein said self-heating temperature sensing elements are a resistive temperature sensors.

6. The system of claim 4 wherein said two resistive temperature sensors on the left side of the heating element are upstream side resistors and the two resistive temperature sensors on the right side of the heating element are downstream side resistors.

7. The system of claim 4 wherein said resistive temperature sensors are self-heated.

8. The system of claim 4 wherein self-heating is achieved by increasing the temperature of resistors by applying power.

9. The system of claim 4 wherein the resistance in said resistive temperature sensors changes with temperature creating a differential voltage signal.

10. The system of claim 1 wherein said analog-to digital converter converts the differential voltage signal to digital signal.

11. The system of claim 1 wherein said digital core performs signal compensation.

12. The system of claim 1 wherein said digital to analog converter gives a ratiometric output.

13. The system of claim 11 wherein said ratiometric output is the ratio of digital to analog converters input to its references.

14. The system of claim 1 wherein a voltage source can be coupled to the first and second heat sensing set.

15. A method for sensing mass air flow comprising:
heating the central heating element;
self-heating the temperature resistive sensors;
creating a differential voltage signal;
converting the differential voltage signal to digital signal;
performing digital compensation of the signal; and
generating a ratiometric output by the digital to analog converter.

16. The method of claim 15 wherein the central heating element is a heating resistor.

17. The method of claim 15 wherein said self-heating is achieved by Increasing the temperature of resistors by applying power.

18. The method of claim 15 wherein resistance of said resistive temperature sensors changes with temperature.

19. The method of claim 15 wherein said ratiometric output is the ratio of said digital to analog converters input to its references.
